(19) United States
(12) Patent Application Publication
(10) Pub. No.: US 2015/0244991 A1
(43) Pub. Date: Aug. 27, 2015

(54) MONITORING CAMERA SYSTEM AND CONTROL METHOD OF MONITORING CAMERA SYSTEM

(71) Applicant: Panasonic Intellectual Property Management Co., Ltd., Osaka (JP)

(72) Inventors: Junko Noda, Fukuoka (JP); Kosuke Hosoi, Fukuoka (JP); Akinobu Tanaka, Fukuoka (JP); Toshihiro Shimizu, Fukuoka (JP)

(21) Appl. No.: 14/629,321

(22) Filed: Feb. 23, 2015

(30) Foreign Application Priority Data
Feb. 24, 2014 (JP) 2014-033040

(51) Int. Cl. H04N 7/18

(52) U.S. Cl. CPC H04N 7/181

(57) ABSTRACT

An image processing camera generates movement information on the basis of an omnidirectional image captured at a fixed field angle, and notifies PTZ camera of first movement information through a network. The PTZ camera analyzes the first movement information, changes a field angle to a specific monitoring target area. The image processing camera transmits second movement information to the PTZ camera. The PTZ camera analyzes the second movement information, captures a projected image of the specific monitoring target area when it is recognized that a current field angle is correct on the basis of the second movement information. Accordingly, an image of the specific monitoring target area is captured in a situation where there is no object such as a figure while monitoring a wide range.

### BACKGROUND OF THE INVENTION

1. Field of the Invention

The present invention relates to a monitoring camera system capturing a projected image of a predetermined monitoring target area and a control method of a monitoring camera system.

2. Description of the Related Art

In the related art, a monitoring camera system monitoring inside a store by using an omnidirectional camera disposed on a ceiling of the store or the like is known. As the related art relevant to such a monitoring camera system, for example, an image distribution device disclosed in Japanese Patent Unexamined Publication No. 2004-208214 is known.

The image distribution device periodically receives an image inside the store which is captured by a network camera, and differentiates whether a figure is reflected on the received image. The image distribution device distributes the image which is differentiated in that the figure is not reflected to a Web server.

The network camera disclosed in Japanese Patent Unexamined Publication No. 2004-208214 is used for capturing an image of a monitoring target area which is designated in a store in advance at a wide range, but for example, is not used for monitoring a display situation of a specific commodity shelf in the store. For example, when the network camera captures an image of the specific commodity shelf in the store, an image of a figure existing in the vicinity of the specific commodity shelf may be captured, the display situation of the specific commodity shelf is concealed by the figure, and it may be difficult to protect privacy of the figure due to a reflection of the figure when a projected image of the display situation of the commodity shelf is captured (refer to FIG. 8A). FIG. 8A is a diagram illustrating an example of a situation in which it is difficult to grasp the display situation of the commodity shelf in a monitoring target area due to the reflection of the figure.

Thus, in the related art, it is difficult to capture an image of a specific monitoring target area in the store including the commodity shelf in a situation where the figure is not reflected even while monitoring the display situation of the commodity shelf at a wide range in the store.

An object of the present invention is to provide a monitoring camera system capturing an image of a specific monitoring target area in a situation where an object such as a figure does not exist while monitoring a wide range and a control method of a monitoring camera system.

### SUMMARY OF THE INVENTION

According to an aspect of the present invention, there is provided a monitoring camera system including a first camera which captures an image at a first field angle; and a second camera which is connected to the first camera to be capable of communicating with each other and captures an image at a variable second field angle, in which the first camera notifies the second camera of movement information indicating a movement of an object in a monitoring target area twice at different timings in a specific monitoring target area set in the first field angle in advance, the second camera changes the second field angle to a field angle corresponding to the specific monitoring target area on the basis of the movement information which is first notified, and when a movement of the object is not detected in the specific monitoring target area, an image of the specific monitoring target area is captured at the second field angle after being changed on the basis of the movement information which is second notified.

According to the aspect of the present invention, movement information indicating whether there is a movement of an object in a monitoring target area is notified to the second camera from the first camera twice at different timings, and when a movement of the object in the specific monitoring target area corresponding to the movement information is not detected, an image of the specific monitoring target area is captured, and thus it is possible to capture an image of the specific monitoring target area in a situation where the object such as a figure does not exist while monitoring a wide range.

### BRIEF DESCRIPTION OF DRAWINGS

FIG. 1 is a schematic view illustrating an operation outline of a monitoring camera system of a first exemplary embodiment;

FIG. 2 is a block diagram specifically illustrating an example of an internal configuration of the monitoring camera system of the first exemplary embodiment;

FIG. 3 is a diagram illustrating registration content of an internal table stored in a state management unit;

FIG. 4 is a diagram illustrating the registration content of a preset value table stored in the state management unit;

FIG. 5 is a sequence diagram illustrating an operation procedure up to image capture processing of a specific monitoring target area in a monitoring camera system of the first exemplary embodiment;

FIG. 6A is a diagram illustrating a situation in which a movement of an object is detected in area 1, and a movement of the object is not detected in area 2, FIG. 6B is an explanatory view of a change in a field angle of a PTZ camera in FIG. 6A, FIG. 6C is a diagram illustrating a situation in which a movement of the object is not detected in areas 1 and 2, and FIG. 6D is an explanatory view of the change in the field angle of the PTZ camera in FIG. 6C;

FIG. 7A is an explanatory view of a monitoring operation when cooperation setting information is added to movement information, and FIG. 7B is an explanatory view of image data of a projected image in an area which is transmitted to an image storage device when areas 1, 2, and 5 are set as a monitoring target group as cooperation setting information;

FIG. 8A is a diagram illustrating an example of a situation in which it is difficult to grasp a display situation of a commodity shelf in a monitoring target area due to reflection of a figure, FIG. 8B is a diagram illustrating an example of a situation in which it is easy to grasp the display situation of the commodity shelf in the monitoring target area due to no reflection of the figure;

FIG. 9 is a sequence diagram illustrating an image capturing operation of the PTZ camera when alarm information is notified;

FIG. 10 is a sequence diagram illustrating an operation procedure up to image capture processing of a specific monitoring target area in a monitoring camera system of a modification example of the first exemplary embodiment;

FIG. 11 is a sequence diagram illustrating an operation procedure up to image capture processing of a specific monitoring target area in a monitoring camera system of a second exemplary embodiment;

FIG. 12 is a sequence diagram illustrating an image capturing operation of a PTZ camera when alarm information is notified;

FIG. 13 is a sequence diagram illustrating an operation procedure up to image capture processing of a specific monitoring target area in a monitoring camera system of a modification example of the second exemplary embodiment;

FIG. 14 is a schematic view illustrating an operation outline of a monitoring camera system of a third exemplary embodiment;

FIG. 15 is a sequence diagram illustrating an operation procedure up to image capture processing of a specific monitoring target area in a monitoring camera system of the third exemplary embodiment;

FIG. 16 is a sequence diagram illustrating a first image capturing operation of a PTZ camera when alarm information is notified;

FIG. 17 is a sequence diagram illustrating a second image capturing operation of the PTZ camera when the alarm information is notified;

FIG. 18 is a sequence diagram illustrating an image capturing operation of the PTZ camera when the alarm information is continuously notified; and

FIG. 19 is a sequence diagram illustrating an operation procedure up to image capture processing of a specific monitoring target area in a monitoring camera system of a modification example of the third exemplary embodiment.

### DETAILED DESCRIPTION OF THE PREFERRED EMBODIMENTS

Each embodiment of a monitoring camera system and a control method of a monitoring camera system according to the present invention will be described with reference to the drawings. In order to facilitate the description of the monitoring camera system of each of the embodiments, for example, it is described that the monitoring camera system is disposed in a store such as a convenience store, but a disposed location is not limited to the store.

### First Exemplary Embodiment

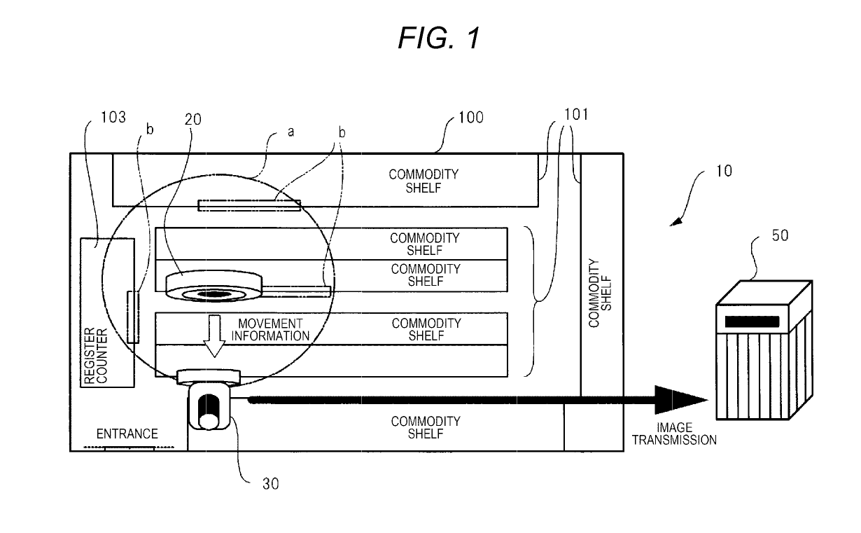

FIG. 1 is a schematic view illustrating an operation outline of monitoring camera system 10 of a first exemplary embodiment. Monitoring camera system 10 illustrated in FIG. 1 includes at least one image processing camera 20 and pan tilt zoom (PTZ) camera 30 which are disposed to be capable of capturing an image of commodity shelf 101, register counter 103, or the like in store 100. Image processing camera 20 and PTZ camera 30 of this embodiment are network cameras which are connected through a network to be capable of communicating with each other.

Image processing camera 20 is disposed on a ceiling surface of store 100, and is an omnidirectional camera which is able to capture an image at 360° from above in the store. For example, in image processing camera 20, a fixed field angle (a first field angle) is set such that an image of a monitoring target area in a circular range indicated by a symbol “a” in FIG. 1 is able to be captured. Furthermore, a field angle of image processing camera 20 may be set to be capable of capturing an entire image inside store 100.

Similarly, PTZ camera 30 is disposed on the ceiling surface of store 100, has each function of moving in a pan direction of a lens, of moving in a tilt direction of the lens, and of zooming in and zooming out, and captures an image of a specific monitoring target area b at a variable field angle (a second field angle).

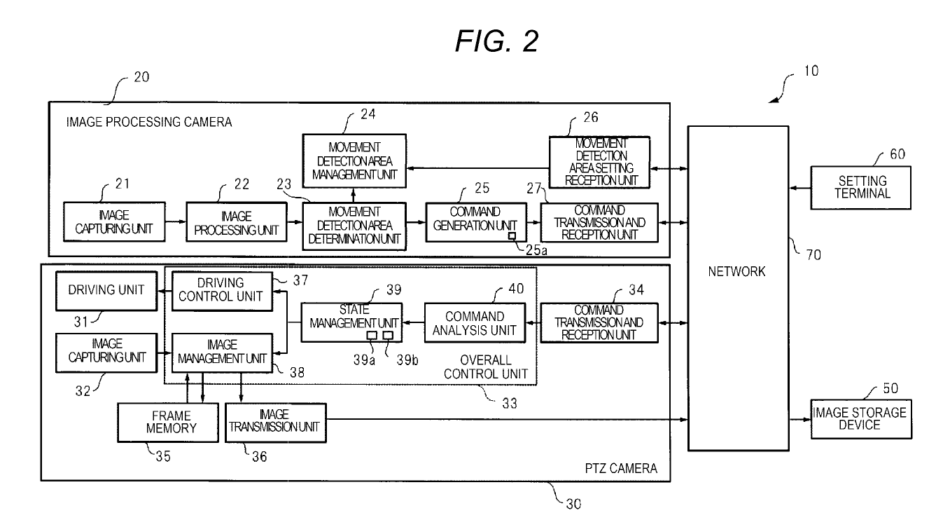

FIG. 2 is a block diagram specifically illustrating an example of an internal configuration of monitoring camera system 10. Monitoring camera system 10 illustrated in FIG. 2 includes image processing camera 20, PTZ camera 30, image storage device 50, and setting terminal 60. Image processing camera 20, PTZ camera 30, image storage device 50, and setting terminal 60 are connected to each other through network 70.

Image processing camera 20 includes image capturing unit 21, image processing unit 22, movement detection area determination unit 23, movement detection area management unit 24, command generation unit 25, movement detection area setting reception unit 26, and command transmission and reception unit 27.

In image capturing unit 21, a fisheye lens is mounted on a front surface of image capturing unit 21, and an image capturing element such as a charge coupled device (CCD) or a complementary metal oxide semiconductor (CMOS) which converts an optical image into an electrical signal is embedded. An image of the electrical signal captured by image capturing unit 21 is input into image processing unit 22.

Image processing unit 22 performs predetermined signal processing (for example, distortion correction, y correction, and cutout of a panorama image) with respect to the electrical signal output from image capturing unit 21, and thus generates a frame of image data of a projected image which is defined by RGB (Red Green Blue), YUV (luminance and a color difference), or the like recognizable by an observer. Image processing unit 22 outputs the frame of the image data of the projected image to movement detection area determination unit 23.

Movement detection area determination unit 23 detects whether or not there is a movement of an object (for example, a figure, and the same applies hereafter) in the image data of the projected image on the basis of the image data of the projected image output from image processing unit 22. Movement detection area determination unit 23 determines whether or not image data is detected in which there is a movement of the object is in a monitoring target area which is registered in movement detection area management unit 24 in advance.

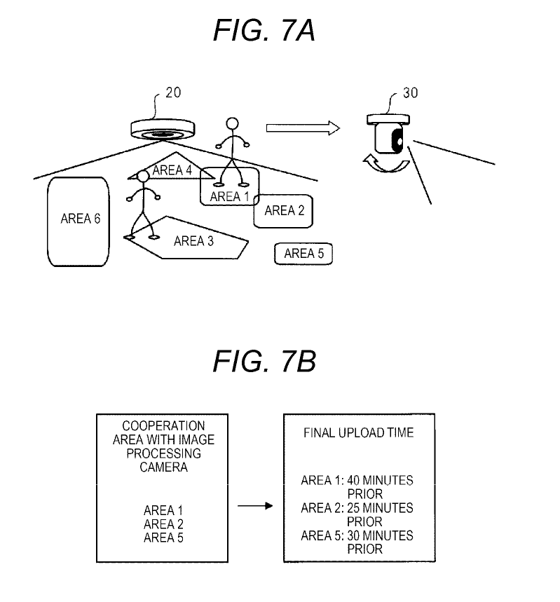

Movement detection area management unit 24 registers information of a monitoring target area (for example, area 1, area 2, . . . illustrated in FIG. 7A) which is set by setting terminal 60 in advance. Hereinafter, the monitoring target area registered by movement detection area management unit 24 is referred to as a “movement detection area”.

Movement detection area setting reception unit 26 receives the information of the monitoring target area (a movement detection area) which is set by setting terminal 60 in advance through network 70, and registers the information of the received monitoring target area (the movement detection area) in movement detection area management unit 24.

Command generation unit 25 includes periodic timer 25a embedded therein, and generates a command for notifying movement information on the basis of a determination result in movement detection area determination unit 23 whenever periodic timer 25a is time out. In the movement information, at least information indicating a specific movement detection area (a monitoring target area) in all monitoring target areas of greater than or equal to one which is a monitoring target of image processing camera 20, and determination result information of whether or not a movement of the object is detected in the specific movement detection area (the monitoring target area) are included, and as necessary, the following cooperation setting information is added.

The cooperation setting information is information for cooperating a plurality of monitoring target areas as one monitoring target group as a monitoring target area of which an image is captured by PTZ camera 30. The cooperated monitoring target area, for example as illustrated in FIG. 7A, is a monitoring target area (specifically, area 1, area 2, and area 5) of which an image is able to be captured by the same PTZ camera 30, and more specifically, is a monitoring target area covering the same commodity shelf.

In addition, when a movement of the object detected by movement detection area determination unit 23 is an unnatural movement (for example, when it is determined that a suspicious figure of which behavior is unnatural appears), command generation unit 25 generates an alarm signal for notification to the outside, and generates a command for notifying PTZ camera 30 of alarm information. In the alarm information, information of the monitoring target area in which the suspicious figure as a target of the alarm is detected is included.

Command transmission and reception unit 27 transmits the command generated by command generation unit 25 to PTZ camera 30 through network 70, and receives a change completion notification as described later from PTZ camera 30.

Next, PTZ camera 30 includes driving unit 31, image capturing unit 32, overall control unit 33, command transmission and reception unit 34, frame memory 35, and image transmission unit 36.

Driving unit 31 includes a motor or the like which moves image capturing unit 32 in the pan direction or in the tilt direction according to a control signal output from overall control unit 33, or performs a zooming operation including zooming in and zooming out. PTZ camera 30 changes a field angle indicating an image capturing range of PTZ camera 30 due to a movement of image capturing unit 32 by driving unit 31.

Image capturing unit 32 includes an image capturing element such as a CCD or a CMOS which converts an optical image into an electrical signal embedded therein. The electrical signal of which an image is captured by image capturing unit 32 is input into image management unit 38 of overall control unit 33.

Command transmission and reception unit 34 receives the movement information notified from image processing camera 20 through network 70, and transmits (returns) the change completion notification to the effect that a change in the field angle of PTZ camera 30 is completed according to a movement of image capturing unit 32 to image processing camera 20 through network 70. Furthermore, even when PTZ camera 30 receives the movement information notified from image processing camera 20, and the field angle of image capturing unit 32 is not changed (that is, the same field angle is used), the change completion notification is transmitted to image processing camera 20.

Overall control unit 33 controls the whole operation of each unit of PTZ camera 30, and specifically, includes driving control unit 37, image management unit 38, state management unit 39, and command analysis unit 40.

When the movement information received by command transmission and reception unit 34 is acquired, command analysis unit 40 analyzes contents of the movement information, and outputs the information indicating the specific movement detection area (the monitoring target area) in all monitoring target areas of greater than or equal to one which is a monitoring target of image processing camera 20, and corresponding cooperation setting information when cooperation setting information is included in the movement information to state management unit 39.

State management unit 39 specifies a monitoring target area which is an image capturing target according to information of priority of image capturing shown in internal table 39a on the basis of the movement detection area (the monitoring target area) and the cooperation setting information, and reads out a preset value which defines the field angle of PTZ camera 30 corresponding to the specified monitoring target area to be output to driving control unit 37.

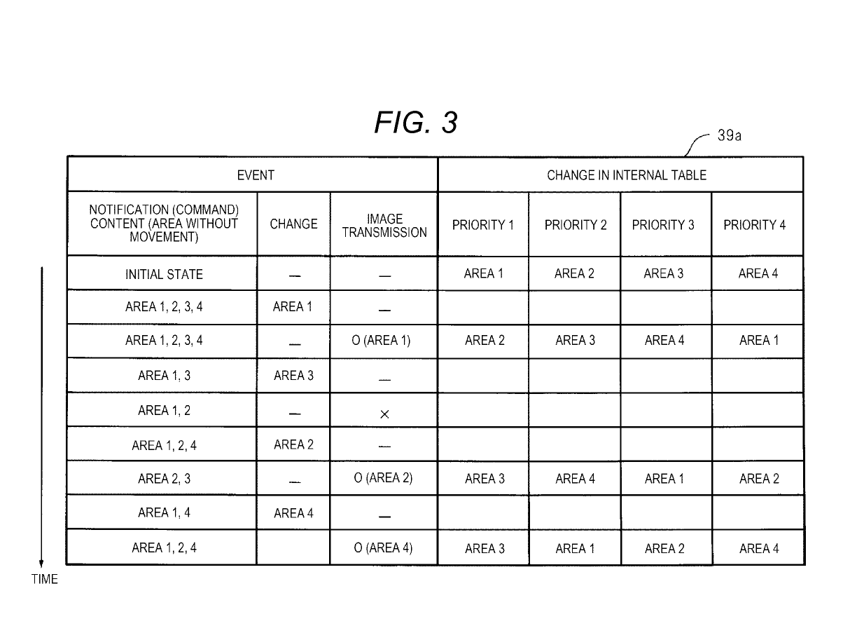

FIG. 3 is a diagram illustrating registration contents of internal table 39a stored in state management unit 39. In internal table 39a illustrated in FIG. 3, priority of image capturing for each monitoring target area (hereinafter, the “monitoring target area” is simply referred to as an “area”) which is changed with an elapse of time is registered.

For example, in an initial state, the priority of image capturing increases in the order of areas 1, 2, 3, and 4. When an image of area 1 is captured and the image is transmitted, state management unit 39 changes the priority of image capturing in the order of areas 2, 3, 4, and 1. In addition, when an image of area 2 is captured and the image is transmitted, state management unit 39 changes the priority of image capturing in the order of areas 3, 4, 1, and 2. That is, when an image of the specific monitoring target area is transmitted, state management unit 39 updates internal table 39a such that the priority of image capturing relevant to the monitoring target area is the lowest.

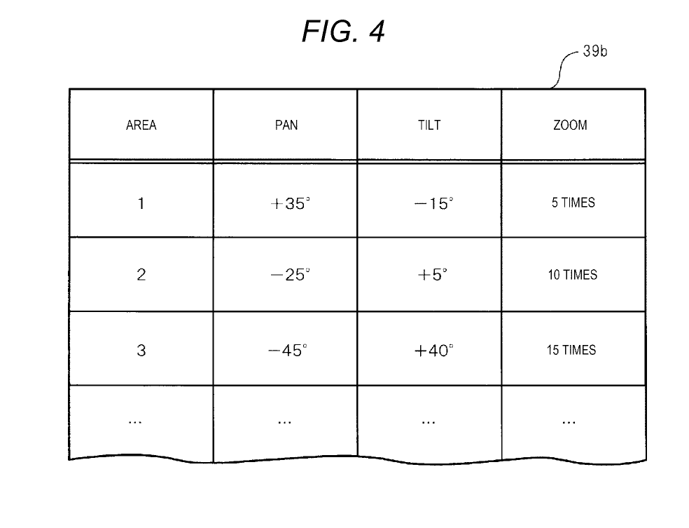

In addition, state management unit 39 stores preset value table 39b in which a preset value which defines parameters in the pan direction, parameters in the tilt direction, and parameters in a zoom magnification is registered such that PTZ camera 30 is able to form a field angle for each image capturing target area. FIG. 4 is a diagram illustrating registration contents of preset value table 39b stored in state management unit 39.

Specifically, in area 1, preset value table 39b registers a preset value for setting PTZ camera 30 to be +30° in the pan direction, −15° in the tilt direction, and 5 times in the zoom magnification with respect to the pan direction, the tilt direction, and the zoom magnification of the initial state. Similarly, in area 2, preset value table 39b registers a preset value for setting PTZ camera 30 to be −25° in the pan direction, +5° in the tilt direction, and 10 times in the zoom magnification with respect to the pan direction, the tilt direction, and the zoom magnification of the initial state. That is, preset value table 39b stores parameters required for the PTZ camera of each embodiment to change the field angle to a preset position corresponding to the preset value.

Driving control unit 37 generates a control signal for controlling an operation of driving unit 31 to be output to driving unit 31 on the basis of data of the preset value read from preset value table 39b by state management unit 39.

Image management unit 38 performs predetermined signal processing with respect to the electrical signal output from image capturing unit 32, and thus generates a frame of image data of a projected image which is defined by RGB (Red Green Blue), YUV (luminance and a color difference), or the like recognizable by an observer to be stored in frame memory 35, and instructs transmission of the image data stored in frame memory 35 to image storage device 50 to image transmission unit 36.

Frame memory 35, for example, is configured by using a Random Access Memory (RAM), and stores the image data generated by image management unit 38 in frame units.

Image transmission unit 36 transmits the image data stored in frame memory 35 to image storage device 50 through network 70 according to the instruction from image management unit 38.

Image storage device 50 is an image server including a storage memory which is able to store the image data transmitted from PTZ camera 30 through network 70.

As network 70, for example, the Internet which is a wide area communication network, an intranet which is a local area communication network (LAN: Local Area Network), and the like are used. In addition, in transmission and reception of the image data between PTZ camera 30 and image storage device 50, for example, a File Transfer Protocol (FTP) or a Hyper Text Transfer Protocol (HTTP) is used.

Setting terminal 60, for example, is an information terminal manipulated by a system manager of a monitoring camera system, and for example, is a Personal Computer (PC), a smart phone, or a tablet terminal. Setting terminal 60 sets a movement detection area as an image capturing target area in the field angle (the first field angle) in the store of which an image is captured by image processing camera 20 according to input manipulation of the system manager. Setting terminal 60 sets the cooperation setting information for cooperating a plurality of monitoring target areas as one monitoring target group as the monitoring target area of which an image is captured by PTZ camera 30 at the time of setting the movement detection area (the monitoring target area).

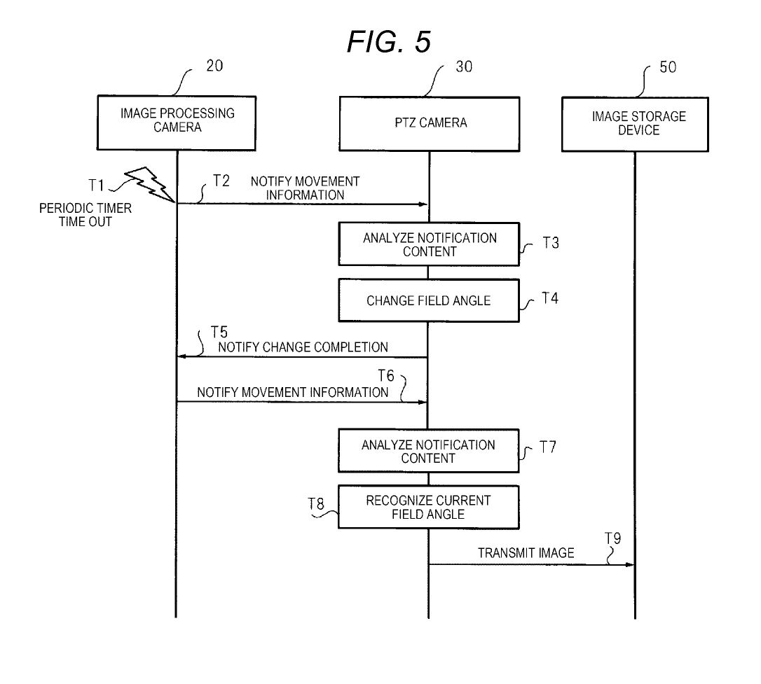

Next, an operation procedure of monitoring camera system 10 of this embodiment will be described with reference to FIG. 5. FIG. 5 is a sequence diagram illustrating an operation procedure up to image capture processing of the specific monitoring target area in monitoring camera system 10 of the first exemplary embodiment.

In FIG. 5, when periodic timer 25a is time out (T1), image processing camera 20 generates movement information indicating whether or not a movement of the object is detected for each monitoring target area in the fixed field angle on the basis of an image analysis result of an omnidirectional image captured at the fixed field angle (the first field angle), and notifies PTZ camera 30 of the movement information generated for each of all monitoring target areas as first movement information (T2).

PTZ camera 30 analyzes the first movement information notified from image processing camera 20 for each monitoring target area (T3), specifies the monitoring target area in which a movement of the object is not detected on the basis of the movement information which is analyzed for each monitoring target area, and changes the field angle (the second field angle) of PTZ camera 30 to a preset position corresponding to the specified monitoring target area (T4).

Here, for example, when the cooperation setting information is added to the movement information, in the movement detection area (the monitoring target area) where a movement of the object is not detected, a monitoring target area which is a monitoring target area included in the cooperation setting information and has the highest priority of image capturing is specified. That is, even in the movement detection area (the monitoring target area), a monitoring target area which is a monitoring target area not included in the cooperation setting information or has low priority of image capturing is excluded.

When the change in the field angle is completed, PTZ camera 30 transmits the change completion notification to the effect that the change in the field angle is completed to image processing camera 20 through network 70 (T5). When the change completion notification is received from PTZ camera 30, image processing camera 20 newly generates a command for notifying movement information, and similar to Step T2, generates movement information indicating whether or not a movement of the object is detected for each monitoring target area in the fixed field angle, and notifies PTZ camera 30 of the generated movement information as second movement information (T6). Furthermore, when the second movement information is generated, in Step T4, PTZ camera 30 may generate at least movement information in the specific monitoring target area where a preset value is set, and the same applies to each of the following embodiments.

PTZ camera 30 analyzes the second movement information notified from image processing camera 20 for each monitoring target area, and confirms that a movement of the object is not detected in the monitoring target area specified by the first movement information (T7). Then, PTZ camera 30 recognizes that the field angle changed in Step T4 is coincident with a current field angle in the monitoring target area which is specified on the basis of the second movement information (T8). When it is recognized that the current field angle is identical to the field angle changed in Step T4, PTZ camera 30 captures an image of the projected image of the specified monitoring target area, and transmits the image data of the projected image of which an image is captured to image storage device 50 through network 70 (T9). Accordingly, image storage device 50 is able to store the image data of the projected image of the monitoring target area specified in Step T4 in association with time information.

Further, in Step T9, PTZ camera 30 may return to the field angle before being changed in Step T4 or the field angle of the initial state, or may maintain the field angle after being changed in Step T4.

Furthermore, in Step T8, when the current field angle is not coincident with the field angle changed in Step T4, in the monitoring target area specified according to the first movement information, the field angle of PTZ camera 30 is changed due to manipulation or the like of the manager between a notification timing of the first movement information and a notification timing of the second movement information, and thus in this case, PTZ camera 30 does not perform transmission with respect to image storage device 50 even when the projected image is not captured or the projected image is captured in Step T9.

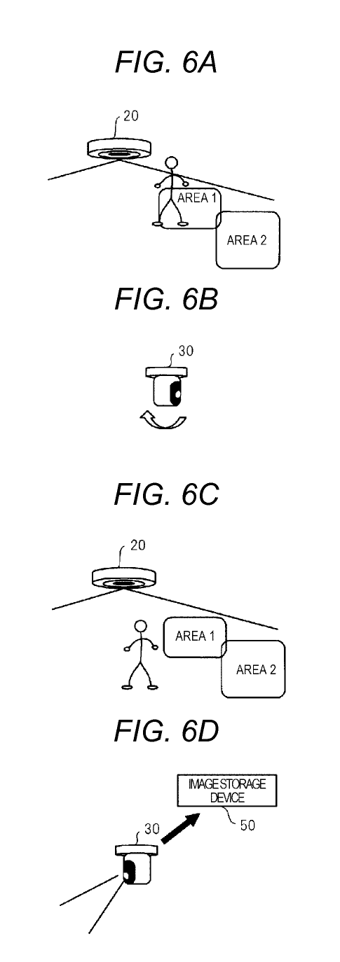

FIG. 6A is a diagram illustrating a situation in which a movement of the object is detected in area 1, and a movement of the object is not detected in area 2. FIG. 6B is an explanatory view of a change in the field angle of the PTZ camera in FIG. 6A. FIG. 6C is a diagram illustrating a situation in which a movement of the object is not detected in areas 1 and 2. FIG. 6D is an explanatory view of a change in the field angle of the PTZ camera in FIG. 6C.

As illustrated in FIG. 6A, the first movement information notified from image processing camera 20 is in a situation where a movement of the object (the figure) is detected in area 1, and a movement of the object (the figure) is not detected in area 2 in the set monitoring target area. When the first movement information is notified from image processing camera 20 to PTZ camera 30, PTZ camera 30 is able to determine that a movement of the object (the figure) is detected in area 1, and a movement of the object (the figure) is not detected in area 2 from the movement information, and thus changes the field angle (the second field angle) of PTZ camera 30 such that an image of area 2 in which a movement of the object (the figure) is not detected is captured (refer to FIG. 6B).

As illustrated in FIG. 6C, after the change in the field angle (the second field angle) of PTZ camera 30 is completed, the second movement information notified from image processing camera 20 is in a situation where movement of the object is not detected in areas 1 and 2. In this case, PTZ camera 30 is able to determine that a movement of the object is not detected in area 2 even in the second movement information from the movement information, and thus captures a projected image of area 2, and uploads (transmits) image data of the captured projected image to image storage device 50 (refer to FIG. 6D).

FIG. 7A is an explanatory view of a monitoring operation when the cooperation setting information is added to the movement information. FIG. 7B is an explanatory view of image data of a projected image of an area which is transmitted to image storage device 50 when areas 1, 2, and 5 are set as the monitoring target group as the cooperation setting information. As illustrated in FIG. 7B, the cooperation setting information is set such that areas 1, 2, and 5 are the monitoring target group. In addition, in all of the monitoring target areas of image processing camera 20, areas 1, 2, 3, 4, 5, and 6 are set in advance (refer to FIG. 7A).

The first movement information notified from image processing camera 20 is in a situation where a movement of the figure is detected in area 1, a movement of a head portion of the other figure is detected in the area 4, a movement of feet of the same figure is detected in area 3, and a movement is not detected in other areas 2, 5, and 6 in all of the set monitoring target areas (areas 1 to 6). Furthermore, area 4 is set in a position higher than that of area 3.

When the movement information is notified to PTZ camera 30, PTZ camera 30 extracts areas 2 and 5 which have determined that a movement of the object (the figure) is not detected from a plurality of areas (areas 1, 2, and 5) included in the cooperation setting information as a candidate of the image capturing target area. In addition, in the plurality of areas (areas 1, 2, and 5) included in the cooperation setting information, as illustrated in FIG. 7B, an image of area 1 is captured 40 minutes prior, an image of area 2 is captured 25 minutes prior, and an image of area 5 is captured 30 minutes prior. As a result thereof, when the movement information is notified for each of the plurality of areas included in the cooperation setting information, priority of image capturing of the area (area 5) having the longest elapsed time from the previous image capturing timing is high, and PTZ camera 30 specifies the area of the image capturing target as area 5 in the plurality of areas included in the cooperation setting information, and changes the field angle such that an image of area 5 is captured. Accordingly, PTZ camera 30 is able to perform preparation for capturing an image of the area in which image capturing is not performed for a long period of time in the plurality of monitoring target areas set as the cooperation setting information.

Furthermore, after the change in the field angle of PTZ camera 30 is completed, PTZ camera 30 analyzes the contents of the second movement information notified from image processing camera 20, and thus when a movement of the object (the figure) is not detected in area 5, a projected image of area 5 is captured, and uploads (transmits) the image data of the captured projected image to image storage device 50. Then, a final upload time of area 5 is reset to 0 minutes.

Thus, image processing camera 20 is able to notify PTZ camera 30 of the movement information for each of the plurality of monitoring target areas set as the cooperation setting information at one time. PTZ camera 30 is able to distribute the image data of the latest projected image of the monitoring target area in which the figure is not detected in the monitoring target area set as the cooperation setting information and the image capturing is not performed for a long period of time on the basis of the movement information notified from image processing camera 20.

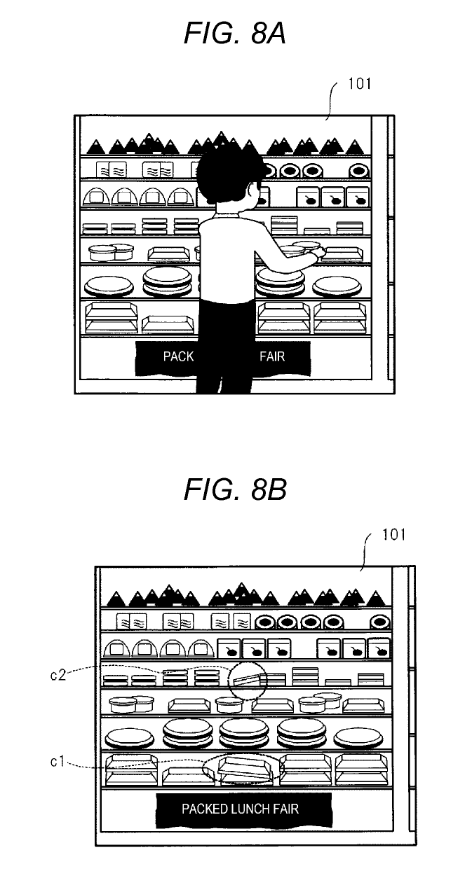

FIG. 8A is a diagram illustrating an example of a situation in which it is difficult to grasp the display situation of the commodity shelf in the monitoring target area due to reflection of the figure. FIG. 8B is a diagram illustrating an example of a situation in which it is easy to grasp the display situation of the commodity shelf in the monitoring target area due to no reflection of the figure. As illustrated in FIG. 8A, when the figure exists in front of the commodity shelf and a movement of the figure is detected, PTZ camera 30 does not transmit a captured image of the commodity shelf. In contrast, as illustrated in FIG. 8B, when the figure does not exist in front of the commodity shelf, and a movement of the figure is not detected, PTZ camera 30 transmits the captured image of the commodity shelf. As a result thereof, monitoring camera system 10 of this embodiment is able to protect privacy when the figure exists in the field angle of PTZ camera 30, and the figure is able to capture an image of the image data of the projected image of a display state (for example, a state in which a display of the commodities is disturbed illustrated by dotted frames c1 and c2 of FIG. 8B) of the commodity shelf.

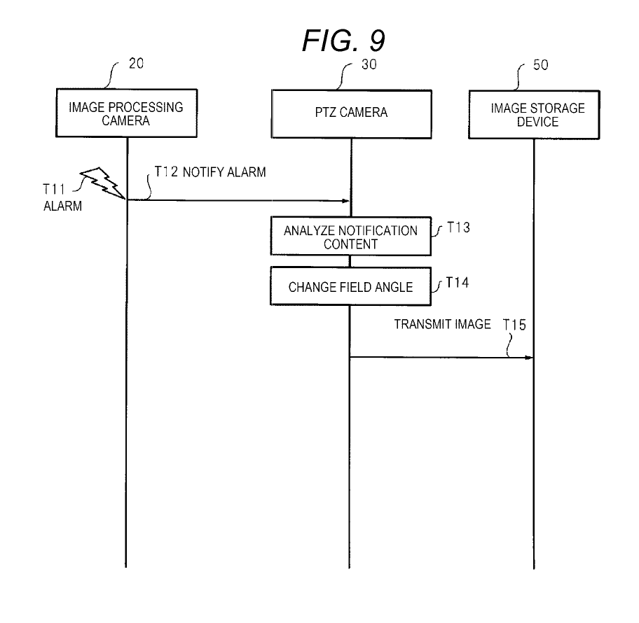

FIG. 9 is a sequence diagram illustrating an image capturing operation of PTZ camera 30 when alarm information is notified. In FIG. 9, for example, when it is determined that an appearance of a suspicious figure of which behavior is unnatural is detected as in a case where an unnatural movement of the object is detected result from the image processing performed with respect to the omnidirectional image captured by image processing camera 20, image processing camera 20 generates an alarm signal for notification to the outside (T11), and notifies PTZ camera 30 of the alarm information to the effect that the unnatural movement of the object (the figure) is detected (T12). In the alarm information, information of the monitoring target area in which an unnatural movement of the object (the figure) is detected is included, and the same applies to each of the following embodiments.

PTZ camera 30 analyzes alarm information notified from image processing camera 20 (T13), specifies the monitoring target area in which the unnatural movement of the object is detected on the basis of the analyzed alarm information, and changes the field angle (the second field angle) of PTZ camera 30 to a preset position corresponding to the specified monitoring target area (T14).

When the change in the field angle (the second field angle) of PTZ camera 30 is completed, PTZ camera 30 captures the projected image of the specified monitoring target area, and transmits the image data of the captured projected image to image storage device 50 through network 70 (T15). Accordingly, image storage device 50 is able to store the projected image of the monitoring target area which is specified as an alarm is generated by PTZ camera 30 in association with time information. Thus, when the unnatural movement of the object is detected, image processing camera 20 generates an alarm, and PTZ camera 30 is able to earlier perform image capturing preparation of the projected image of the monitoring target area which is specified by the notification of the alarm information on the basis of only one notification of alarm information, and is able to instantly capture the projected image of the monitoring target area.

Thus, in monitoring camera system 10 of this embodiment, as an analysis result of the omnidirectional image captured by image processing camera 20 itself, image processing camera 20 notifies the movement information including information of whether or not a movement of the object is detected to each monitoring target area at least two times. Accordingly, PTZ camera 30 is able to monitor a wide range in the store or the like while cooperating with image processing camera 20, and is able to capture an image of a specific area such as the commodity shelf in a situation where the figure or the like does not exist on the basis of the movement information notified from image processing camera 20 at least two times.

Accordingly, monitoring camera system 10 is able to capture an image in a situation where the figure is not moved in the field angle of PTZ camera 30, and thus is able to accurately protect privacy of the figure (for example, a customer) in the store, and is able to accurately capture an image of the display situation of the commodities without concealing the commodities by the figure.

In addition, PTZ camera 30 does not move the field angle with respect to the monitoring target area in which a movement of the object is detected in the first movement information, and thus monitoring camera system 10 of this embodiment is able to simplify the operation with respect to PTZ camera 30. In addition, image processing camera 20 periodically notifies PTZ camera 30 of the movement information, and thus monitoring camera system 10 of this embodiment is able to easily monitor the plurality of monitoring target areas.

In addition, in monitoring camera system 10 of this embodiment, the change completion notification of the field angle (the second field angle) returns (is transmitted) to image processing camera 20 from PTZ camera 30, and thus it is possible to rapidly notify image processing camera 20 of the second movement information, and it is possible to reduce a period of time for the image capturing operation of PTZ camera 30.

### Modification Example of First Exemplary Embodiment

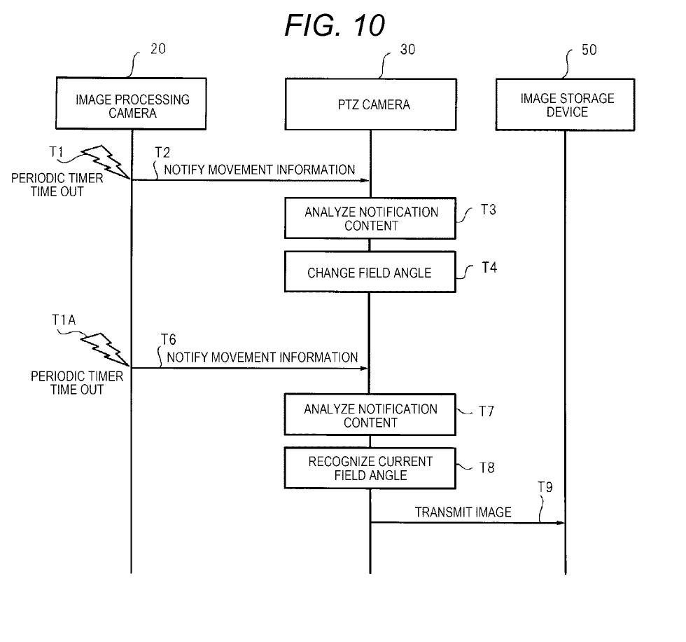

FIG. 10 is a sequence diagram illustrating an operation procedure up to the image capture processing of the specific monitoring target area in monitoring camera system 10 of a modification example of the first exemplary embodiment. In the description illustrated in FIG. 10, the same reference numerals are used for the same operation as that in the description illustrated in FIG. 5, and thus the description thereof will be simplified or omitted, and different contents will be described. In the modification example of the first exemplary embodiment, even when the change in the field angle (the second field angle) is completed, PTZ camera 30 does not notify image processing camera 20 of the change completion notification.

Specifically, after the first movement information is notified to PTZ camera 30, as an example of a predetermined period of time, for example, when 6 seconds as a time which is assumed that PTZ camera 30 completes the change in the field angle in advance (hereinafter, referred to as a “predictive change completion time”) has elapsed by a count of periodic timer 25a (T1A), image processing camera 20 generates the second movement information and notifies PTZ camera 30 of the second movement information (T6). The predictive change completion time, for example, is registered in periodic timer 25a of command generation unit 25 of image processing camera 20 by input manipulation of system manager manipulating setting terminal 60 in advance. The predictive change completion time is described as 6 seconds, but it is not limited to 6 seconds, and for example, may be suitably changed by the input manipulation of the system manager with respect to setting terminal 60.

Thus, in the modification example of the first exemplary embodiment, even when the change completion notification of the field angle (the second field angle) is not received from PTZ camera 30, image processing camera 20 generates the second movement information and notifies PTZ camera 30 of the second movement information after the predictive change completion time registered in advance has elapsed. Similar to the first exemplary embodiment, PTZ camera 30 captures an image of the specific monitoring target area on the basis of the second movement information transmitted after periodic timer 25a is time out. Accordingly, in the modification example of the first exemplary embodiment, it is possible to omit the operation of the change completion notification in PTZ camera 30, and thus it is possible to simplify a configuration of overall control unit 33 of PTZ camera 30.

### Second Exemplary Embodiment

In the first exemplary embodiment described above, an example of a case where image processing camera 20 and PTZ camera 30 are connected in one-to-one is described. In a second exemplary embodiment, an example of monitoring camera system 10A in which a plurality of (for example, two) PTZ cameras 30A and 30B are connected to one image processing camera 20 is described. An image processing camera and a PTZ camera of the second exemplary embodiment have a configuration approximately identical to that of the first exemplary embodiment described above, and thus the description thereof will be simplified or omitted by using the same reference numerals or the corresponding reference numerals for the same constituents as that of the first exemplary embodiment.

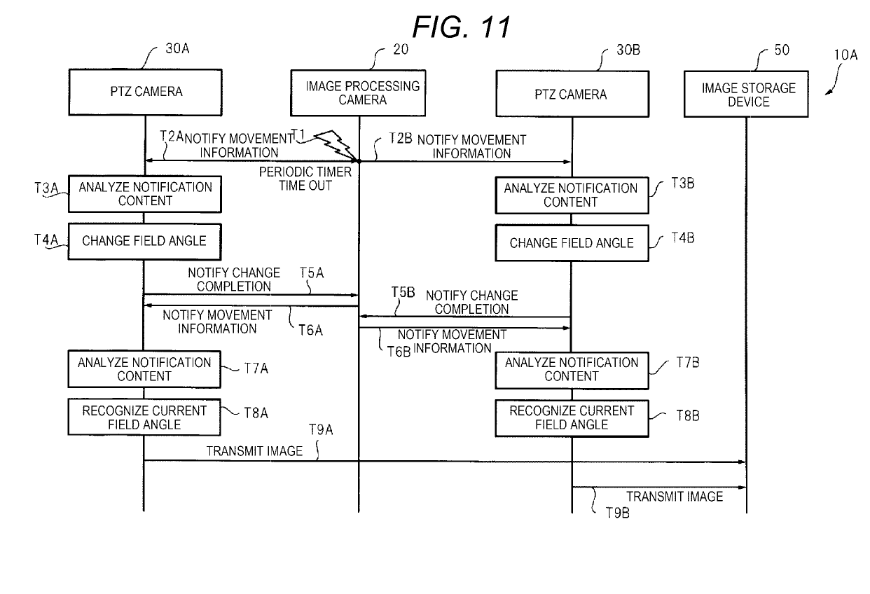

FIG. 11 is a sequence diagram illustrating an operation procedure up to image capture processing of a specific monitoring target area in monitoring camera system 10A of a second exemplary embodiment. In the description of FIG. 11, the same reference numerals or the corresponding reference numerals are applied to the same operation or the corresponding operation as that of the sequence diagram illustrated in FIG. 5, and thus the description thereof will be simplified or omitted.

In FIG. 11, when periodic timer 25a is time out (T1), image processing camera 20 generates the movement information indicating whether or not a movement of the object is detected for each monitoring target area in the fixed field angle on the basis of an image analysis result of the omnidirectional image captured in the fixed field angle (the first field angle), and notifies each of PTZ cameras 30A and 30B of the movement information generated for each of the all monitoring target areas as the first movement information (T2A and T2B).

Each of PTZ cameras 30A and 30B analyzes the first movement information notified from image processing camera 20 for each monitoring target area (T3A and T3B), and changes a field angle of PTZ cameras 30A and 30B to a preset position corresponding to the monitoring target area in which the movement of the object is not detected on the basis of the analyzed movement information for each monitoring target area (T4A and T4B).

Here, similar to the first exemplary embodiment described above, for example, when the cooperation setting information is added to the movement information, a monitoring target area which is included in the cooperation setting information and has the highest priority of image capturing is specified in the movement detection area (the monitoring target area) where a movement of the object is not detected. That is, in the movement detection area (the monitoring target area), the monitoring target area which is not included in the cooperation setting information or has low priority of image capturing is excluded. In addition, the cooperation setting information is set such that a plurality of monitoring target areas to be cooperated with each of PTZ cameras 30A and 30B are different from each other.

When the change in the field angle is completed, each of PTZ cameras 30A and 30B transmits the change completion notification to the effect that the change in the field angle is completed and a movement completion notification to image processing camera 20 through network 70 (T5A and T5B). When each of PTZ cameras 30A and 30B receives the change completion notification, image processing camera 20 generates a command for newly notifying the movement information, and similar to Steps T2A and T2B, generates the movement information indicating whether or not a movement of the object is detected for each monitoring target area in the fixed field angle, and transmits the generated movement information to PTZ cameras 30A and 30B as the second movement information (T6A and T6B).

Each of PTZ cameras 30A and 30B analyzes the second movement information notified from image processing camera 20, and confirms that there is no movement of the object in the monitoring target area specified by the first movement information (T7A and T7B). Then, PTZ cameras 30A and 30B recognize that the current field angle is coincident with a field angle changed in Steps T4A and T4B with respect to the monitoring target area specified on the basis of the second movement information (T8A and T8B). When it is recognized that the current field angle is the field angle changed in Steps T4A and T4B, PTZ cameras 30A and 30B capture the projected image of the specified monitoring target area, and transmit the image data of the captured projected image to image storage device 50 through network 70 (T9A and T9B). Accordingly, image storage device 50 is able to store the image data of the projected image of the monitoring target area specified by PTZ cameras 30A and 30B in Steps T4A and T4B in association with the time information.

Further, in Steps T9A and T9B, PTZ cameras 30A and 30B may return to the field angle before being changed in Steps T4A and T4B or the field angle of the initial state, and may maintain the field angle after being changed in Steps T4A and T4B.

Furthermore, when the current field angles in Steps T8A and T8B are not coincident with the field angles changed in Steps T4A and T4B, respectively, the field angle of PTZ cameras 30A and 30B is changed by the manipulation or the like of the manager between the notification timing of the first movement information and the notification timing of the second movement information, and thus in this case, PTZ cameras 30A and 30B do not perform the transmission with respect to image storage device 50 even when the projected image is not captured or the projected image is captured in Steps T9A and T9B.

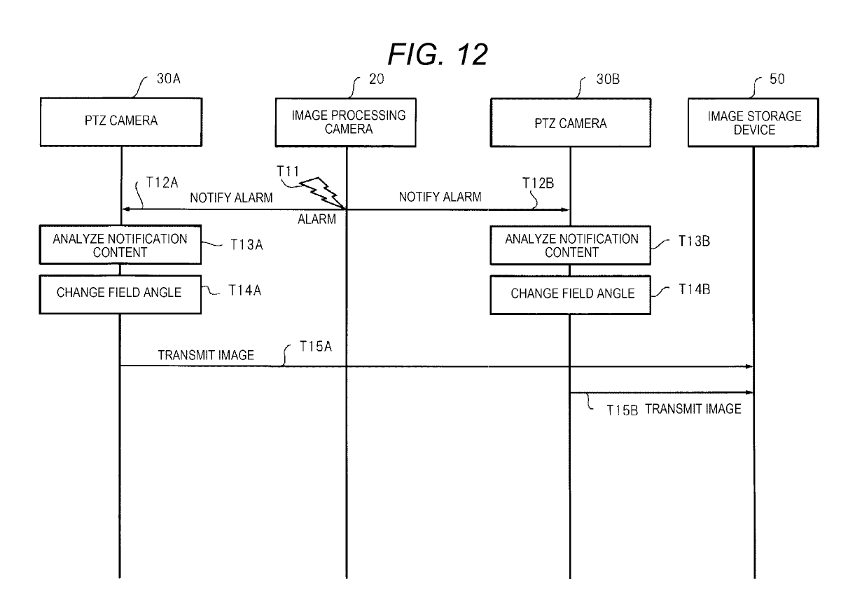

FIG. 12 is a sequence diagram illustrating an image capturing operation of PTZ cameras 30A and 30B when alarm information is notified. In the description of FIG. 12, the same reference numerals or the corresponding reference numerals are applied to the same operation or the corresponding operation as that of the sequence diagram illustrated in FIG. 9, and thus the description thereof will be simplified or omitted.

In FIG. 12, for example, when it is determined that a suspicious figure of which behavior is unnatural is detected as in a case where an unnatural movement of the object is detected resulted from the image processing performed with respect to the omnidirectional image captured by image processing camera 20, image processing camera 20 generates an alarm signal for notification to the outside (T11), and notifies PTZ cameras 30A and 30B of the alarm information to the effect that the unnatural movement of the object (the figure) is detected (T12A and T12B). In the alarm information, information of the monitoring target area in which an unnatural movement of the object (the figure) is detected is included.

Each of PTZ cameras 30A and 30B analyzes the alarm information notified from image processing camera 20 (T13A and T13B), specifies the monitoring target area in which the unnatural movement of the object is detected on the basis of the analyzed alarm information, and changes the field angle (the second field angle) of PTZ cameras 30A and 30B to a preset position corresponding to the specified monitoring target area (T14A and T14B). Furthermore, PTZ cameras 30A and 30B may capture an image of the same image capturing target area, and may capture an image of the monitoring target areas of which parts are overlapped.

When the change in the field angle (the second field angle) of PTZ cameras 30A and 30B is completed, each of PTZ cameras 30A and 30B captures the projected image of the specified monitoring target area, and transmits the image data of the captured projected image to image storage device 50 through network 70 (T15A and T15B). Accordingly, image storage device 50 is able to store the projected image of the monitoring target area which is specified as an alarm is generated by PTZ cameras 30A and 30B in association with the time information.

As described above, in monitoring camera system 10A of the second exemplary embodiment, the same effect as that of monitoring camera system 10 of the first exemplary embodiment is obtained, and a plurality of PTZ cameras 30A and 30B are able to capture an image of the same monitoring target area, for example, are able to capture an image of the display state of the same commodity shelf from a different angle. In addition, when the unnatural movement of the object is detected, image processing camera 20 generates an alarm, PTZ cameras 30A and 30B are able to early perform the image capturing preparation of the projected image of the monitoring target area specified by the alarm notification on the basis of only one alarm notification, and are able to instantly capture the projected image of the monitoring target area.

### Modification Example of Second Exemplary Embodiment

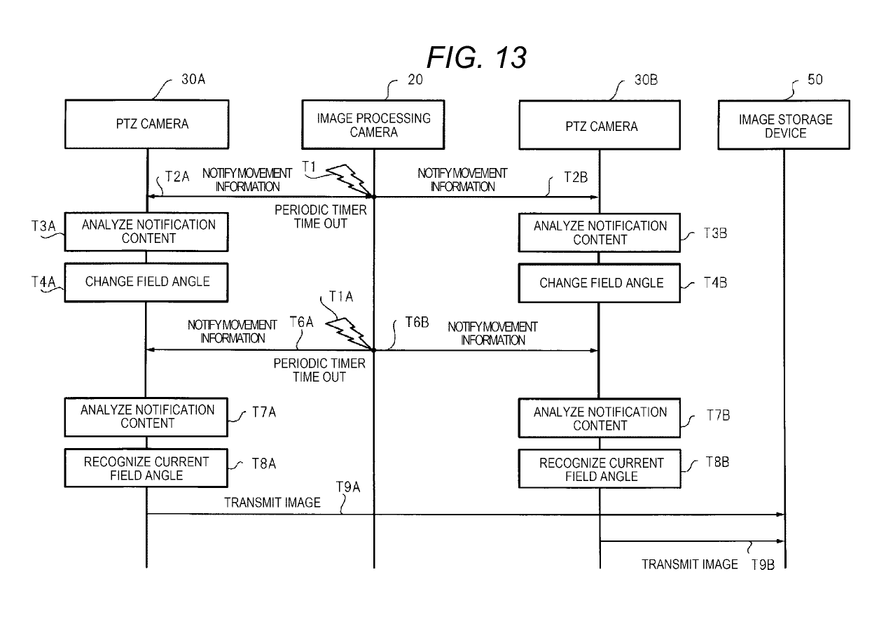

FIG. 13 is a sequence diagram illustrating an operation procedure up to image capture processing of a specific monitoring target area in monitoring camera system 10A of a modification example of the second exemplary embodiment. In the description illustrated in FIG. 13, the same reference numerals are used for the same operation as that in the description illustrated in FIG. 11, and thus the description thereof will be simplified or omitted, and different contents will be described. In the modification example of the second exemplary embodiment, even when the change in the field angle is completed, PTZ cameras 30A and 30B do not notify image processing camera 20 of the change completion notification.

Specifically, after the first movement information is notified to PTZ cameras 30A and 30B, when 6 seconds as a predictive change completion time which is set with respect to image processing camera 20 in advance has elapsed by a count of periodic timer 25a (T1A), image processing camera 20 generates the second movement information and notifies PTZ cameras 30A and 30B of the second movement information (T6A and T6B). The predictive change completion time is registered in periodic timer 25a of command generation unit 25 of image processing camera 20 in advance.

Thus, in the modification example of the second exemplary embodiment, even when the change completion notification of the field angle (the second field angle) is not received from each of PTZ cameras 30A and 30B, image processing camera 20 generates the second movement information and notifies each of PTZ cameras 30A and 30B of the second movement information after the predictive change completion time registered in advance has elapsed. Similar to the second exemplary embodiment, PTZ cameras 30A and 30B capture an image of the specific monitoring target area on the basis of the second movement information transmitted after periodic timer 25a is time out. Accordingly, in the modification example of the second exemplary embodiment, it is possible to omit the operation of the change completion notification in PTZ cameras 30A and 30B, and thus it is possible to simplify a configuration of the overall control unit of PTZ cameras 30A and 30B.

Furthermore, in the second exemplary embodiment and the modification example thereof described above, three or more PTZ cameras may be connected to one image processing camera 20, and even in this case, the same effect is obtained. In addition, each of a plurality of PTZ cameras may return (transmit) the change completion notification to the effect that the field angle (the second field angle) is changed to image processing camera 20.

### Third Exemplary Embodiment

In a third exemplary embodiment, an example of monitoring camera system 10B in which one PTZ camera 30 is connected to a plurality of (for example, two) image processing cameras 20A and 20B is described. An image processing camera and a PTZ camera of the third exemplary embodiment have a configuration approximately identical to that of the first exemplary embodiment described above, and thus the description thereof will be simplified or omitted by using the same reference numerals or the corresponding reference numerals for the same constituents as that of the first exemplary embodiment.

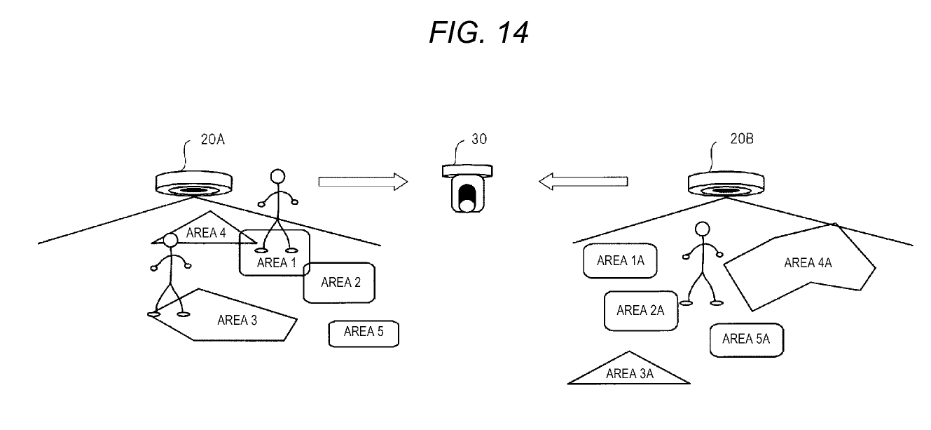

FIG. 14 is a schematic view illustrating an operation outline of monitoring camera system 10B of the third exemplary embodiment. Image processing camera 20A periodically generates movement information relevant to the set area (for example, areas 1 to 5) and notifies PTZ camera 30 of the movement information. In addition, the cooperation setting information which is set in image processing camera 20A in advance is added to the movement information. Similarly, image processing camera 20B periodically generates the movement information relevant to the area (for example, areas 1A to 5A) which is set in advance and notifies PTZ camera 30 of the movement information at a timing different from that of image processing camera 20A or a timing identical to that of image processing camera 20A and at a notification cycle which is identical to a notification cycle of image processing camera 20A or different from the notification cycle of image processing camera 20A.

Furthermore, in FIG. 14, areas 1 to 5 and areas 1A to 5A may be set such that parts are overlapped, or may be set as an independent area of each other. In addition, when all of areas 1 to 5 are coincident with areas 1A to 5A, image processing camera 20B may not perform generation and notification of the movement information.

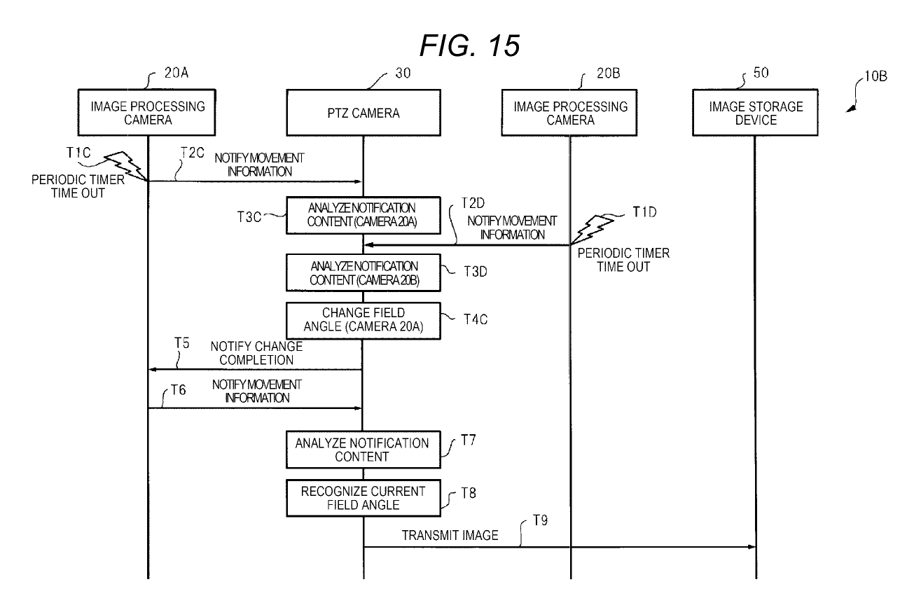

FIG. 15 is a sequence diagram illustrating an operation procedure up to image capture processing of a specific monitoring target area in monitoring camera system 10B of the third exemplary embodiment. In the description of FIG. 15, the same reference numerals or the corresponding reference numerals are applied to the same operation or the corresponding operation as that of the sequence diagram illustrated in FIG. 5, and thus the description thereof will be simplified or omitted.

Here, the notification cycle at which image processing cameras 20A and 20B notify PTZ camera 30 of the movement information, that is, a timer value of periodic timer 25a is able to be arbitrarily set. In this embodiment, a case where from a timing when the first movement information is notified from one image processing camera to a timing when the image data is transmitted to image storage device 50, PTZ camera 30 receives a notification of the first movement information from the other image processing camera is described.

In FIG. 15, when periodic timer 25a is time out (T1c), image processing camera 20A generates the movement information indicating whether or not a movement of the object is detected for each monitoring target area in the fixed field angle on the basis of the image analysis result of the omnidirectional image captured at the fixed field angle (the first field angle) of image processing camera 20A, and notifies PTZ camera 30 of the movement information which is generated for each of all monitoring target areas as the first movement information (T2C).

PTZ camera 30 analyzes the first movement information notified from image processing camera 20A for each monitoring target area, and specifies the monitoring target area in which a movement of the object is not detected on the basis of the analyzed movement information for each monitoring target area (T3C).

After Step T3C, when periodic timer 25a is time out (T1D), image processing camera 20B generates the movement information indicating whether or not a movement of the object is detected for each monitoring target area in the fixed field angle on the basis of the image analysis result of the omnidirectional image captured at the fixed field angle (the first field angle) of image processing camera 20B, and notifies PTZ camera 30 of the movement information which is generated for each of all monitoring target areas as the first movement information (T2D).

PTZ camera 30 analyzes the first movement information notified from image processing camera 20B for each monitoring target area, and specifies the monitoring target area in which a movement of the object is not detected on the basis of the analyzed movement information for each monitoring target area (T3D).

PTZ camera 30 changes the field angle of PTZ camera 30 to a preset position corresponding to the monitoring target area specified by the analysis of Step T3C by giving priority to the first movement information notified from image processing camera 20A which is firstly notified among two first movement information items respectively notified from image processing cameras 20A and 20B (T4C).

Here, similar to the first exemplary embodiment described above, for example, when the cooperation setting information set in image processing camera 20A is added to the first movement information notified from image processing camera 20A, a monitoring target area which is included in the cooperation setting information and has the highest priority of image capturing is specified in the movement detection area (the monitoring target area) where a movement of the object is not detected. That is, even in the movement detection area (the monitoring target area), a monitoring target area which is not included in the cooperation setting information or has low priority of image capturing is excluded.

Steps T5 to T9 after Step T4C are identical to that of the first exemplary embodiment, and thus the description thereof will be omitted. Accordingly, image storage device 50 is able to store the image data of the projected image of the monitoring target area specified by PTZ camera 30 in Step T4C in association with the time information. Accordingly, in Step T2D, the first movement information notified from image processing camera 20B is cancelled in PTZ camera 30.

Further, in Step T9, PTZ camera 30 may return to the field angle before being changed in Step T4C or the field angle of the initial state, and may maintain the field angle after being changed in Step T4C.

Furthermore, when the current field angle in Step T8 is not coincident with the field angle changed in Step T4C, the field angle of PTZ camera 30 is changed by the manipulation or the like of the manager between the notification timing of the first movement information and the notification timing of the second movement information, and thus in this case, it is considered that the display situation of the commodity shelf is concealed by the object (for example, the figure), and PTZ camera 30 does not perform the transmission with respect to image storage device 50 even when the projected image is not captured or the projected image is captured in Step T9.

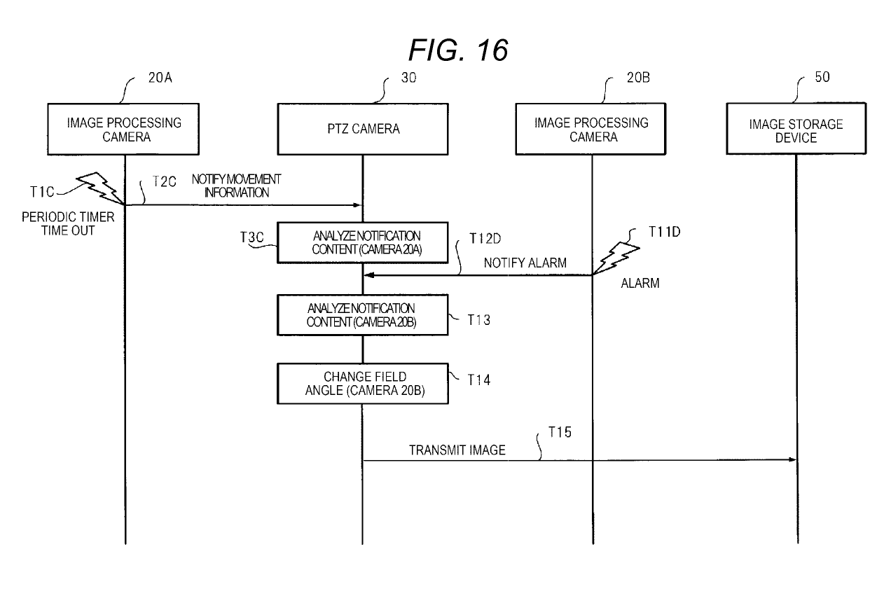

FIG. 16 is a sequence diagram illustrating a first image capturing operation of PTZ camera 30 when alarm information is notified. In FIG. 16, an operational example of monitoring camera system 10B when PTZ camera 30 receives the alarm information notified from the other image processing camera 20B before changing the field angle (the second field angle) according to the first movement information notified from image processing camera 20A is described.

In FIG. 16, when periodic timer 25a is time out (T1C), image processing camera 20A generates the movement information indicating whether or not a movement of the object is detected for each monitoring target area in the fixed field angle on the basis of the image analysis result of the omnidirectional image captured at the fixed field angle (the first field angle) of image processing camera 20A, and notifies PTZ camera 30 of the movement information which is generated for each of all monitoring target areas as the first movement information (T2C).

PTZ camera 30 analyzes the first movement information notified from image processing camera 20A for each monitoring target area, and specifies the monitoring target area in which a movement of the object is not detected on the basis of the analyzed movement information for each monitoring target area (T3C).

After Step T3C, for example, when it is determined that a suspicious figure of which behavior is unnatural is detected as in a case where an unnatural movement of the object is detected resulted from the image processing performed with respect to the omnidirectional image captured by image processing camera 20B, image processing camera 20B generates an alarm signal for notification to the outside (T11D), and notifies PTZ camera 30 of the alarm information to the effect that the unnatural movement of the object (the figure) is detected (T12D).

PTZ camera 30 cancels the first movement information notified from image processing camera 20A in Step T2C, priorly analyzes the alarm information notified from image processing camera 20B in Step T12D (T13), specifies the monitoring target area in which the unnatural movement of the object is detected on the basis of the analyzed alarm information, and changes the field angle (the second field angle) of PTZ camera 30 to a preset position corresponding to the specified monitoring target area (T14).

When the change in the field angle (the second field angle) of PTZ camera 30 is completed, PTZ camera 30 captures the projected image of the specified monitoring target area, and transmits the image data of the captured projected image to image storage device 50 through network 70 (T15). Accordingly, image storage device 50 is able to store the projected image of the monitoring target area which is specified as an alarm is generated by PTZ camera 30 in association with the time information.

Thus, when the unnatural movement of the object is detected, image processing camera 20B generates an alarm, and PTZ camera 30 gives priority to the alarm information notified from image processing camera 20B without capturing the projected image of the monitoring target area specified corresponding to the first movement information notified from image processing camera 20A.

In other words, when a reception timing of the movement information and a reception timing of the alarm information are overlapped or when there is a time difference in a predetermined period (for example, a few seconds, and the same applies hereafter), PTZ camera 30 priorly handles image processing camera 20B notifying the alarm information, and thus for example, is able to capture the projected image of the monitoring target area corresponding to the alarm information notified from image processing camera 20B in an emergency situation. In addition, PTZ camera 30 is able to early perform image capturing preparation of the projected image of the monitoring target area which is specified by the notification of the alarm information on the basis of only one notification of alarm information, and is able to instantly capture the projected image of the monitoring target area.

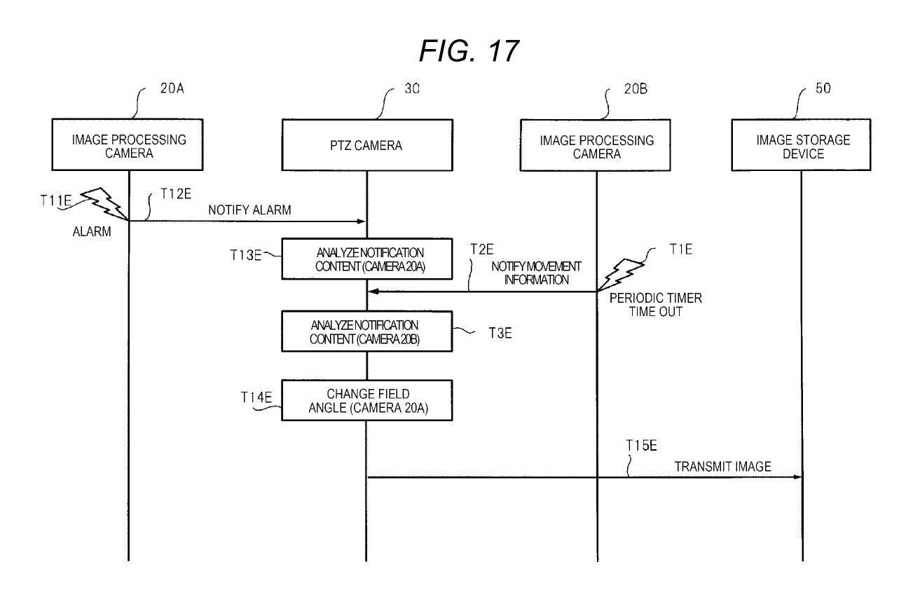

FIG. 17 is a sequence diagram illustrating a second image capturing operation of the PTZ camera when the alarm information is notified. In FIG. 17, an operational example of monitoring camera system 10B when PTZ camera 30 receives the first movement information periodically notified from the other image processing camera 20B before changing the field angle (the second field angle) according to the alarm information notified from image processing camera 20A is described.

In FIG. 17, for example, when it is determined that an appearance of a suspicious figure of which behavior is unnatural is detected as in a case where an unnatural movement of the object is detected result from the image processing performed with respect to the omnidirectional image captured by image processing camera 20A, image processing camera 20A generates an alarm signal for notification to the outside (T11E), and notifies PTZ camera 30 of the alarm information to the effect that the unnatural movement of the object (the figure) is detected (T12E).

PTZ camera 30 analyzes the alarm information notified from image processing camera 20B (T13E), and specifies the monitoring target area in which the unnatural movement of the object is detected on the basis of the analyzed alarm information.

After Step T13E, when periodic timer 25a is time out (T1E), image processing camera 20B generates the movement information indicating whether or not a movement of the object is detected for each monitoring target area in the fixed field angle on the basis of the image analysis result of the omnidirectional image captured at the fixed field angle (the first field angle) of image processing camera 20A, and notifies PTZ camera 30 of the movement information which is generated for each of all monitoring target areas as the first movement information (T2E).

PTZ camera 30 analyzes the first movement information notified from image processing camera 20B for each monitoring target area, and specifies the monitoring target area in which a movement of the object is not detected on the basis of the analyzed movement information for each monitoring target area (T3E).

PTZ camera 30 cancels the first movement information notified from image processing camera 20B in Step T2E, and changes the field angle (the second field angle) of PTZ camera 30 to a preset position corresponding to the monitoring target area specified in Step T3E by giving priority to the alarm information notified from image processing camera 20A in Step T13E (T14E).

When the change in the field angle (the second field angle) of PTZ camera 30 is completed, PTZ camera 30 captures the projected image of the specified monitoring target area, and transmits the image data of the captured projected image to image storage device 50 through network 70 (T15E). Accordingly, image storage device 50 is able to priorly store the projected image of the monitoring target area which is a notification target of the alarm information specified by PTZ camera 30 in association with the time information.

Thus, when the notification timing of the alarm information is prior to the notification timing of the movement information, PTZ camera 30 priorly handles image processing camera 20A notifying the alarm information, and thus for example, is able to capture the projected image of the monitoring target area corresponding to the alarm information notified from image processing camera 20A in an emergency situation. In addition, PTZ camera 30 is able to early perform image capturing preparation of the projected image of the monitoring target area which is specified by the notification of the alarm on the basis of only one notification of alarm information, and is able to instantly capture the projected image of the monitoring target area.

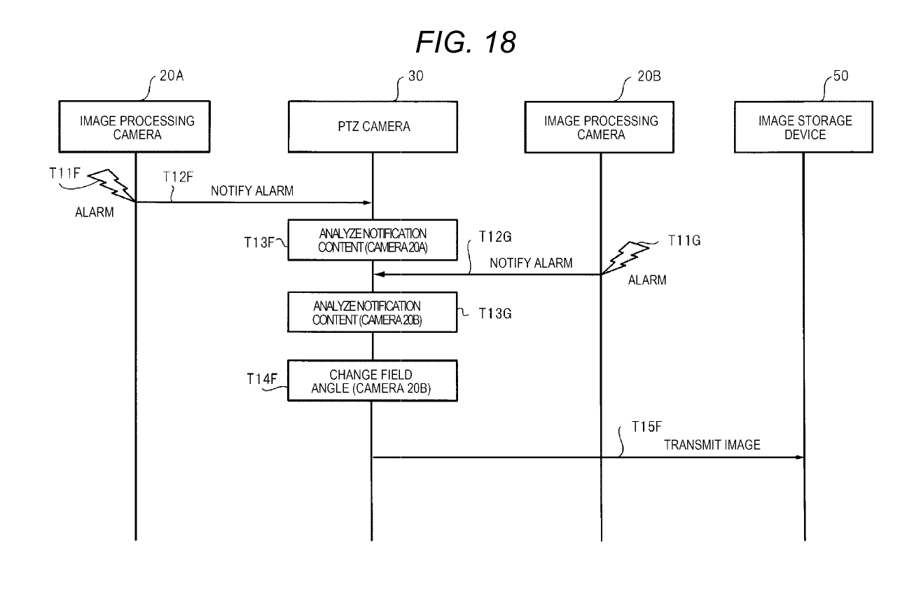

FIG. 18 is a sequence diagram illustrating an image capturing operation of PTZ camera 30 when the alarm information is continuously notified. In FIG. 18, an operational example of monitoring camera system 10B when PTZ camera 30 receives the alarm information notified from the other image processing camera 20B before changing the field angle (the second field angle) according to the alarm information notified from image processing camera 20A is described.

In FIG. 18, for example, when it is determined that an appearance of a suspicious figure of which behavior is unnatural is detected as in a case where an unnatural movement of the object is detected result from the image processing performed with respect to the omnidirectional image captured by image processing camera 20A, image processing camera 20A generates an alarm signal for notification to the outside (T11F), and notifies PTZ camera 30 of the alarm information to the effect that the unnatural movement of the object (the figure) is detected (T12F).

PTZ camera 30 analyzes the alarm information notified from image processing camera 20A (T13F), and specifies the monitoring target area in which the unnatural movement of the object is detected on the basis of the analyzed alarm information.

After Step T13F, for example, when it is determined that an appearance of a suspicious figure of which behavior is unnatural is detected as in a case where an unnatural movement of the object is detected result from the image processing performed with respect to the omnidirectional image captured by image processing camera 20B, image processing camera 20B generates an alarm signal for notification to the outside (T11G), and notifies PTZ camera 30 of the alarm information to the effect that the unnatural movement of the object (the figure) is detected (T12G).

PTZ camera 30 analyzes the alarm information notified from image processing camera 20B (T13G), and specifies the monitoring target area in which the unnatural movement of the object is detected on the basis of the analyzed alarm information.

When a plurality of (for example, two) alarm information items is continuously received, PTZ camera 30 changes the field angle (the second field angle) of PTZ camera 30 to a preset position corresponding to the monitoring target area according to the alarm information notified from image processing camera 20B by giving priority to the recently received alarm information, that is, the alarm information notified from image processing camera 20B (T14F).

When the change in the field angle (the second field angle) of PTZ camera 30 is completed, PTZ camera 30 captures the projected image of the specified monitoring target area, and transmits the image data of the captured projected image to image storage device 50 through network 70 (T15F). Accordingly, image storage device 50 is able to store the projected image of the monitoring target area corresponding to the alarm information from image processing camera 20B which is given priority by PTZ camera 30 and is recently notified from PTZ camera 30 in association with time information.

Thus, when the alarm information is continuously notified from a plurality of image processing cameras 20A and 20B, PTZ camera 30 is able to early perform the image capturing preparation of the projected image of the monitoring target area specified by the notification of the alarm information by giving priority to the recently notified alarm information, and is able to instantly capture the projected image of the monitoring target area.

As described above, according to monitoring camera system 10B of the third exemplary embodiment, when notification timings of the periodically notified movement information are overlapped or are between a predetermined period, PTZ camera 30 is able to capture the projected image of the monitoring target area in which the image capturing is not performed for a long period of time by giving priority to the initially notified movement information. In addition, when the alarm information is notified, each of the plurality of image processing cameras 20A and 20B notifies the alarm information once, and thus PTZ camera 30 is able to capture the projected image of the monitoring target area by giving priority to the recently received alarm information.

### Modification Example of Third Exemplary Embodiment

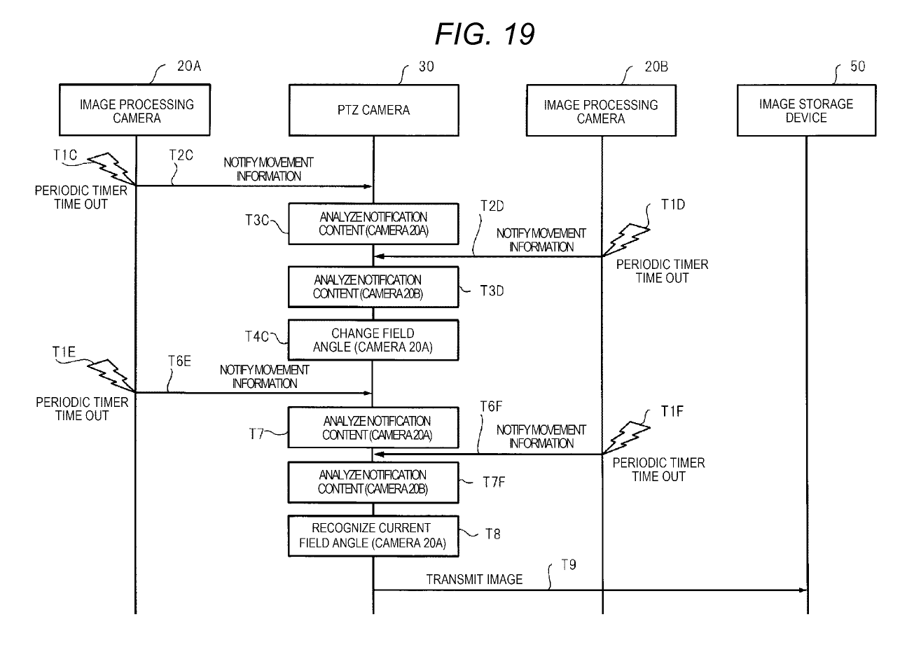

FIG. 19 is a sequence diagram illustrating an operation procedure up to image capture processing of the specific monitoring target area in monitoring camera system 10B of a modification example of the third exemplary embodiment. In the description of FIG. 19, the same reference numerals or the corresponding reference numerals are applied to the same operation or the corresponding operation as that of the sequence diagram illustrated in FIG. 15, and thus the description thereof will be simplified or omitted. In the modification example of the third exemplary embodiment, even when the change in the field angle is completed, PTZ camera 30 does not notify image processing cameras 20A and 20B of the change completion notification.

In FIG. 19, after the first movement information is notified to PTZ camera 30, when 6 seconds as a predictive change completion time which is set with respect to image processing camera 20A in advance has elapsed by a count of periodic timer 25a (T1E), image processing camera 20A generates the second movement information, and then notifies PTZ camera 30 of the second movement information (T6E). PTZ camera 30 analyzes the second movement information notified from image processing camera 20A (T7).

Similarly, after the first movement information is notified to PTZ camera 30, when 6 seconds as a predictive change completion time which is set with respect to image processing camera 20B in advance has elapsed by a count of periodic timer 25a (T1F), image processing camera 20B generates the second movement information, and then notifies PTZ camera 30 of the second movement information (T6F). PTZ camera 30 analyzes the second movement information notified from image processing camera 20B (T7F). The predictive change completion time is registered in periodic timer 25a of each command generation unit 25 of image processing cameras 20A and 20B in advance.

PTZ camera 30 recognizes that the current field angle (the second field angle) is coincident with the field angle for capturing an image of the monitoring target area specified by the analysis of Step T7 by giving priority to the first movement information notified from the firstly notified image processing camera 20A among the two first movement information items notified from each of image processing cameras 20A and 20B (T8). Operations after Step T8 are identical to that of FIG. 15, and thus the description thereof will be omitted.

Thus, in the modification example of the third exemplary embodiment, even when the change completion notification of the field angle (the second field angle) does not return (is not transmitted) to each of image processing cameras 20A and 20B from PTZ camera 30, PTZ camera 30 is able to receive the second movement information when periodic timer 25a of each of image processing cameras 20A and 20B is time out, and thus it is possible to simplify a configuration of the overall control unit of PTZ camera 30. Furthermore, even when one PTZ camera 30 is connected to three or more image processing cameras, the same effect is obtained.

As described above, various embodiments are described with reference to the drawings, but the present invention is not limited to such an example. It is obvious that a person skilled in the art is able to conceive various change examples or correction examples in a category described in the Claims, and it is understood that these change examples or correction examples naturally belong to the technical range of the present invention.

For example, in the embodiments described above, the image processing camera is an omnidirectional camera capable of capturing an image at 360°, but may be a wide angle camera having a wide field angle. In addition, in the embodiments described above, the image data of PTZ camera 30 is transmitted to image storage device 50, but may be simply transmitted to a display device (a monitor).

In addition, in the embodiments described above, a monitoring camera system capturing an image of an inside of the store is described, but the present invention may be applied to a monitoring camera system capturing an image of a specific outdoor location.

What is claimed is:

1. A monitoring camera system, comprising:
a first camera which captures an image at a first field angle; and
a second camera which is connected to the first camera to be capable of communicating with each other and captures an image at a variable second field angle,
wherein the first camera notifies the second camera of movement information indicating a movement of an object in a monitoring target area twice at different timings in a specific monitoring target area set in the first field angle in advance,
the second camera changes the second field angle to a field angle corresponding to the specific monitoring target area on the basis of the movement information which is first notified, and
when a movement of the object is not detected in the specific monitoring target area, an image of the specific monitoring target area is captured at the second field angle after being changed on the basis of the movement information which is second notified.

2. The monitoring camera system of claim 1,
wherein when first movement information indicates that there is a movement of the object in the monitoring target area, the second camera does not change the second field angle.

3. The monitoring camera system of claim 1,
wherein the first camera notifies second movement information after a predetermined period of time has elapsed at which it is assumed that the second camera completes the change in the second field angle.

4. The monitoring camera system of claim 1,
wherein the second camera notifies the first camera that the change in the second field angle is completed, and
the first camera notifies the second movement information according to a notification to the effect that the change in the second field angle is completed from the second camera.

5. The monitoring camera system of claim 1,
wherein the first camera notifies the second camera of movement information for each of a plurality of monitoring target areas set in the first field angle in advance at one time.

6. The monitoring camera system of claim 1,
wherein the first camera notifies the second camera of the movement information including cooperation setting information in which the plurality of monitoring target areas is cooperated as a monitoring target group, and
the second camera determines the specific monitoring target area on the basis of the movement information including the first cooperation setting information.

7. The monitoring camera system of claim 6,
wherein when the first movement information is notified to each monitoring target area of the monitoring target group from the first camera, the second camera priorly captures an image of a monitoring target area having a long elapsed time from a previous image capturing timing.

8. The monitoring camera system of claim 1,
wherein when alarm information is notified from the first camera, the second camera changes the second field angle to a field angle corresponding to an alarm area indicated by the alarm information, and captures an image of the alarm area at the second field angle after being changed.

9. The monitoring camera system of claim 1,
wherein a plurality of the second cameras is connected to the first camera to be capable of communicating with each other, and
each of the plurality of second cameras changes the second field angle to a field angle corresponding to the specific monitoring target area on the basis of the first movement information notified from the first camera.

10. The monitoring camera system of claim 1,
wherein a plurality of first cameras is connected to the second camera to be capable of communicating with each other, and
when the first movement information is notified from each of the plurality of first cameras, the second camera changes the second field angle by giving priority to the first movement information from the first camera which is firstly notified.

11. The monitoring camera system of claim 10,
wherein when a notification timing of the first movement information which is notified from any one of the plurality of first cameras overlaps with a notification timing of alarm information which is notified from the other first camera, the second camera changes the second field angle by giving priority to the alarm information, and captures an image of a monitoring target area indicated by the alarm information.

12. The monitoring camera system of claim 10,
wherein when notification timings of alarm information which is notified from each of the plurality of first cameras are overlapped, the second camera changes the second field angle by giving priority to the alarm information which is finally notified, and captures an image of a monitoring target area indicated by the alarm information which is finally notified.

13. A control method of a monitoring camera system including a first camera which captures an image at a first field angle, and a second camera which is connected to the first camera to be capable of communicating with each other and captures an image at a variable second field angle, the method comprising:
notifying the second camera of first movement information indicating a movement of an object in a monitoring target area in the monitoring target area which is set in the first field angle in advance by the first camera;
changing the second field angle to a field angle corresponding to a specific monitoring target area on the basis of the movement information which is first notified by the second camera;
notifying the second camera of second movement information indicating a movement of the object in the monitoring target area by the first camera; and
capturing an image of the specific monitoring target area at the second field angle after being changed on the basis of the movement information which is second notified when a movement of the object is not detected in the specific monitoring target area by the second camera.
